(19) United States
(12) Patent Application Publication
(10) Pub. No.: US 2025/0258595 A1
(43) Pub. Date: Aug. 14, 2025

(54) SYSTEMS AND METHODS FOR IMPROVING USER INTERFACES AND USER CONTROL

(71) Applicant: Matthew Victory, Cleburne, TX (US)

(72) Inventor: Matthew Victory, Cleburne, TX (US)

(21) Appl. No.: 18/441,307

(22) Filed: Feb. 14, 2024

(51) Int. Cl. G06F 3/04847; G06F 3/04842; G06F 40/166

(52) U.S. Cl. CPC G06F 3/04847; G06F 3/04842; G06F 40/166

(57) ABSTRACT

According to one embodiment, a system is configured to manage how and when information is displayed to a user to ensure the displays are tailored to specific conditions and to optimize user interactions with respective displays. In some embodiments, the system is specially configured to work with productivity and/or office management software and tailor associated user interface displays to specific context and limitations on any information displayed. In the backend, the underlying architecture captures and manages volumes of information, but selectively displays targeted subsets of that information. Each interaction can be managed by the system to capture time logged information and/or to modify properties that control when and how that information will be subsequently displayed.

### BACKGROUND

Computer systems and interfaces are ubiquitous in daily task and activities. Management of the information on display and interaction with the same becomes a constant challenge. Especially, when one considered e-mails, calendars, and time management as the un-ending tasks presented whenever one interacts with their computer system.

### SUMMARY

The inventor has realized that how user interfaces are architected and how those interfaces display information have become a source of many problems with conventional software and conventional displays. According to one aspect, a system is configured to manage how and when information is displayed to a user to ensure the displays are tailored to specific conditions and to optimize user interactions with respective displays. In some embodiments, the system is specially configured to work with productivity and/or office management software and tailor associated user interface displays to specific context and limitations on any information displayed. In the backend, the underlying architecture captures and manages volumes of information, but selectively displays targeted subsets of that information. Each interaction can be managed by the system to capture time logged information and/or to modify properties that control when and how that information will be subsequently displayed.

According to one embodiment, a primary display shows only visual objects matching a specific context or state. For example, a primary display screen or portion of the display screen can be optimized to show only visual objects having display information that matches a current visualization threshold. In some examples, the visualization threshold can be based on current time, current owner, and current date, and/or combinations of the same. Updates to any of those parameters, triggers the system to re-determine when a visual object should appear in the primary display (often eliminating visual objects from the current display in response to modification of: visual object owner, target display information, completion of sub-tasks, etc.). Further embodiments, include additional visualization that provide access to detailed information for respective visual objects, and can include time based log information for each access and/or any action taken with respect to a visual object.

According to one aspect, a system for improving execution displays, the system comprising is provided. The system comprises at least one processor operatively connected to a memory, the at least one processor when executing configured to generate a primary display of visual objects created and encoded with modifiable display information, priority, and time based log information associated with any activity performed on respective visual objects, match the modifiable display information to current state, and in response to determining the match allow the display of any visual objects matching the current state and disallow the display of visual objects having non-matching current state in the primary display, a database of visual objects comprising a plurality of visual objects encoded with the modifiable display information, the priority information, assigned user information, and data fields for log information, and generate a visual object creation interface for accepting user specification of the modifiable display information, the priority, and the assigned user information associated with a respective visual object.

According to one embodiment, the at least one processor is configured to generate, responsive to user selection, a secondary display of visual objects without filtering on the modifiable display state information. According to one embodiment, the at least one processor is configured to require a transition from the primary display to the secondary display in order to render the visual objects without filtering. According to one embodiment, the at least one processor is configured to generate a display of a selectable object in the user interface, the selectable object configured to accept information for controlling when a visual object can be displayed. According to one embodiment, the at least one processor is configured to override at least one other display property based on the information controlling when the visual object can be displayed. According to one embodiment, the at least one processor is configured to accept definition of a visual object including at least a title field, description field, priority field, assigned user field, an optional client field, an optional deadline field, and an optional do not display until field. According to one embodiment, the at least one processor is configured to present visual entry fields to collect information include the at least a title field, the description field, the priority field, the assigned user field, the optional client field, the optional deadline field, and the optional do not display until field. According to one embodiment, the at least one processor is configured to automatically adjust display characteristics responsive to action taken on a respective visual object. According to one embodiment, the at least one processor is configured to disable do not display functionality in response to a deadline associated with a respective visual object being satisfied. According to one embodiment, the at least one processor updates the primary display additively and in override of a current modifiable display setting responsive to selection in the user interface.

According to one aspect, a method for displaying improved execution displays is provided. The method comprises generating, by at least one processor, a primary display of visual objects created and encoded with modifiable display information, priority, and time based log information associated with any activity performed on respective visual objects, matching, by the at least one processor, the modifiable display information to current state, and in response to determining the match allowing the display of any visual objects matching the current state and disallowing the display of visual objects having non-matching current state in the primary display, maintaining, by the at least one processor, a database of visual objects comprising a plurality of visual objects encoded with the modifiable display information, the priority information, assigned user information, and data fields for log information, and generating, by the at least one processor, a visual object creation interface for accepting user specification of the modifiable display information, the priority, and the assigned user information associated with a respective visual object.

According to one embodiment, the method further comprises generating, by the at least one processor, a secondary display of visual objects without filtering on the modifiable display state information responsive to user selection. According to one embodiment, the method comprises requiring, by the at least one processor, a transition from the primary display to the secondary display in order to render the visual objects without filtering. According to one embodiment, the method comprises generating, by the at least one processor, a display of a selectable object in the user interface, the selectable object configured to accept information for controlling when a visual object can be displayed. According to one embodiment, the method comprises overriding, by the at least one processor, at least one other display property based on the information controlling when the visual object can be displayed. According to one embodiment, the method comprises accepting, by the at least one processor, definition of a visual object including at least a title field, description field, priority field, assigned user field, an optional client field, an optional deadline field, and an optional do not display until field. According to one embodiment, the method comprises presenting, by the at least one processor, visual entry fields to collect information include the at least a title field, the description field, the priority field, the assigned user field, the optional client field, the optional deadline field, and the optional do not display until field. According to one embodiment, the method further comprises automatically adjusting, by the at least one processor, display characteristics responsive to action taken on a respective visual object. According to one embodiment, the method comprises disabling, by the at least one processor, do not display functionality in response to a deadline associated with a respective visual object being met. According to one embodiment, the method comprises updating, by the at least one processor, the primary display additively and in override of a current modifiable display setting responsive to selection in the user interface.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of an example system, according to one embodiment;

FIG. 2 is an example screen capture of a primary display, according to one embodiment;

FIG. 3 is an example screen capture of a client information display, according to one embodiment;

FIG. 4 is an example screen capture of a visual object creation display, according to one embodiment;

FIG. 5 is an example screen capture of a time based log display, according to one embodiment;

FIG. 6 is an example screen capture of a time based log display, according to one embodiment;

FIG. 7 is an example process flow, according to one embodiment; and

FIG. 8 is a block diagram of an example special purpose computer system improved by the functions and/or processes disclosed herein.

### DETAILED DESCRIPTION

Various embodiments provide improved interaction with visual objects displayed in a user interface. According to one embodiment, “Tasker” is an implementation of the improved architecture that facilitates user interaction with task management functionality. In some examples, the improved interaction and/or functionality enabled by Tasker can be implemented as standalone software, application programming interfaces that integrate the improved functionality into existing program suites, and/or as a web-interface.

According to some embodiments, systems and methods are provided to manage how and when information is displayed to a user to ensure that the displays are tailored to specific conditions and to optimize user interactions with respective displays. In some embodiments, the system is specially configured to work with productivity and/or office management software and tailor associated user interface displays to specific context and limitations on any information displayed. In some examples, the improved functionality can be specifically tailored for small businesses or teams working in a collaborative environment, as the small team setting (e.g., limited number of users (e.g., 5-10, 10-15, 15-20, etc.) setting can be configured intuitively on the system with little or no technical burden. Further embodiments can be configured to handle larger group settings seamlessly, for example, by building and/or defining a number of teams and assigning users to specific team groups.

The underlying architecture (e.g., of Tasker) captures and manages volumes of information, but selectively displays targeted subsets of that information. Each user interaction can be managed by the system to capture time logged information and/or to modify properties that control when and how that information will be subsequently displayed even across teams of users. The system unambiguously provides time-logged details on all activity, and also limits display of that information to specific user interfaces to avoid overwhelming end users, and to optimize the display architecture, and even optimize use of limited display screens in the context of mobile or small display profile devices.

In one example, the system builds and manages displays of task lists via task generation interfaces and primary displays of tasks that are selectively shown from a database organizing respective tasks and associated information. According to one embodiment, a task creator defines an object specifying task, and a responsible user (e.g., with a default as the creator), and an associated display time. The current responsible user can take action on the task and assuming the display criteria is met it will be shown in a primary display of the currently responsible user. The actions include the ability to transition responsibility by assignment to another user, while again specifying display criteria, which can be based on a priority or customized display criteria. Users of the system only see the visual object defining a task in their primary display list if the display criteria is met. For example, the visual object includes an associated display time that matches a current status (e.g., current time, date, etc.). The system is configured to automatically modify display times for the visual object as assigned users take action, re-assign the task, specific a priority for a next action, etc.

For example, the task creator may not see their created task again in their primary display as other assigned users take action on it resulting in modified display times at respective actions and for respective users, until, for example, a final verification for the visual object is shown. The final verification can include confirmation of completion of an associated task defined by the visual object that is displayed to the creator user. This is markedly different and in fact the opposite from conventional systems and approaches, for example, which display available tasks that are simply ordered on a degree of importance or priority. The results of such conventional approaches cause users to lose focus, and even consume system resources needlessly (e.g., display screen space, processing, and network bandwidth, among other options). Thus, the tailored displays, time based logging, priority and responsibility assignment improve over various conventional approaches. Further embodiments enable users to access the underlying information and/or non-displayed visual objects, based on transitioning to secondary and/or other displays. This separation again improves over known systems that attempt to organize and display all such information, and streamline user interface and the computer resources needed to present them.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element, or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

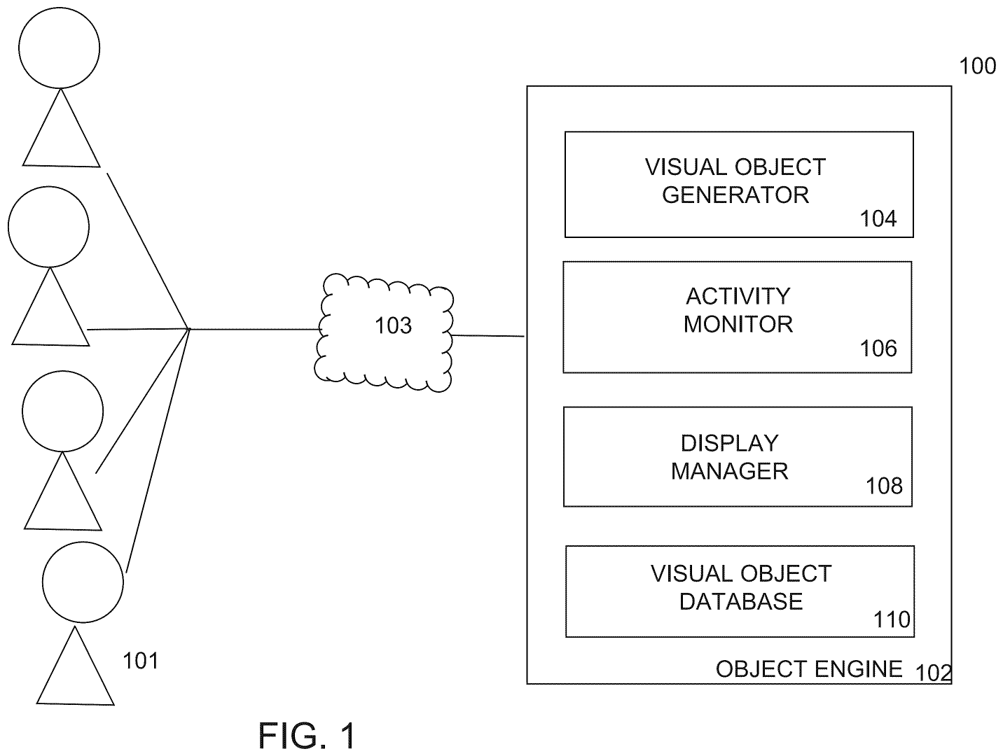

FIG. 1 is an example block diagram of a system 100 configured to manage user interface displays and underlying display of visual objects to optimize information shown, and for example, limit the information shown in primary displays according to display criteria. According to some embodiments, the system is configured to permit users to build visual objects that encode specific tasks and assign associated visual objects to responsible users. According to one embodiment, as part of generation of a visual object the system provides overlay displays to detail the information associated with a respective object. In some examples, the primary display of current visual objects can be preserved while creating additional objects and/or user assignments.

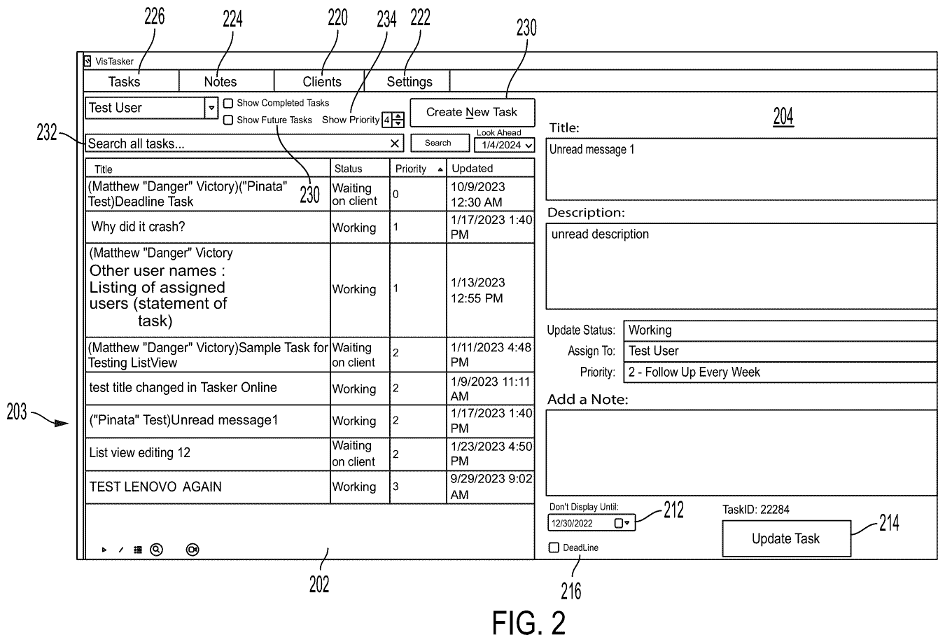

Returning to FIG. 1, the system 100 can include a plurality of components, each configured to perform respective operation and/or function. In other embodiments, the system and/or a visual object engine 102 executed by at least one processor can be configured to execute any of the functions and/or operations disclosed without instantiation of any one or any combination of the components. As shown in FIG. 1, the system 100 and/or engine 102 can include a visual object generator component 104 configured to create and/or update visual objects for display according to display properties. The display properties can include user assignment, priority, and/or time constraints, among other options. The display properties can be used, for example, by a display manager component 108 to organize and show information in primary displays to end users. The display component 108 can be further configured to manage collaboration and display of visual objects to other users (e.g., 101) of the system 100. Further, the display manager component is configured to update display properties as user actions are taken on visual objects, user assignments are made to visual objects, etc. According to one embodiment, the primary display (see e.g., FIG. 2, 202) of visual objects shows a list of visual objects having display properties that match a current context. The display properties can be based on creator information, assigned/responsible user information, priority information etc.

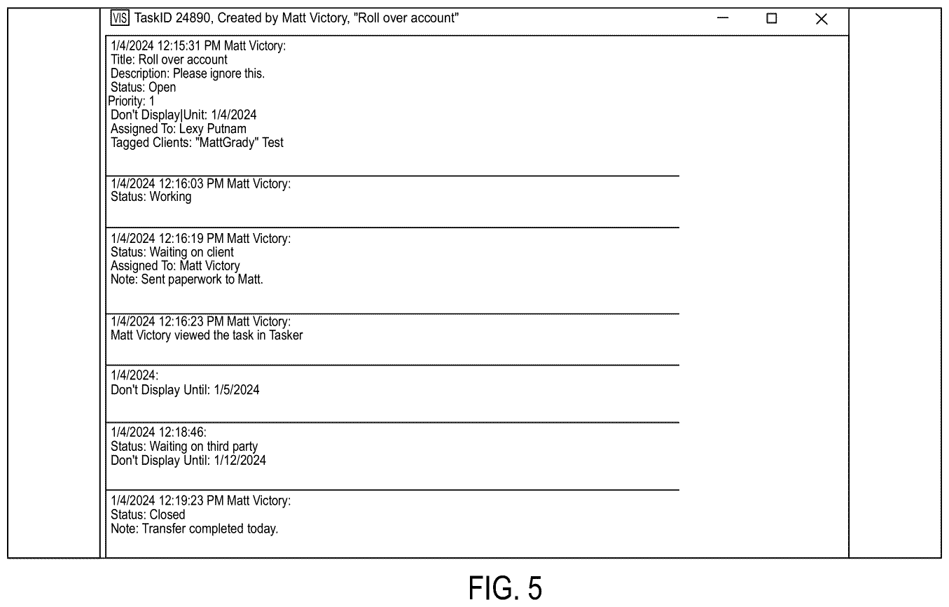

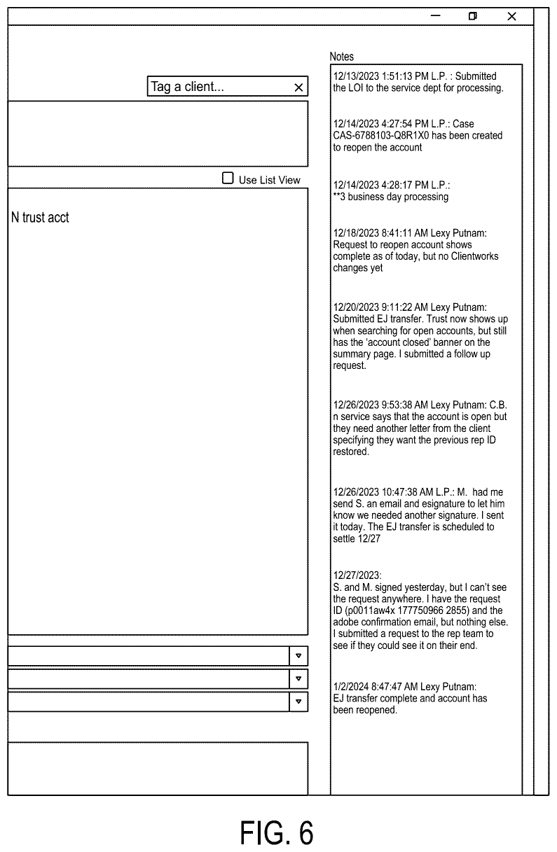

In further embodiments, the user interface created by the display manager can include a detailed information display (see e.g., FIG. 2, 204) for a selected visual object (e.g., 203). According to one embodiment, the detailed display provides detailed information on respective visual objects and includes, for example, time stamp activity log information (e.g., FIG. 5 or 6). The log information can reflect and display, for example, recorded system based actions, associated users, and time of action in an activity log display (e.g., FIG. 5 or 6). Various embodiments include tools for capturing detailed information, activity information, etc. (e.g., at 210), that trigger, for example, the visual object generator 104 to update information associated with a respective visual object. Shown in FIG. 2 at 212 is a “Don't Display Until” visual indicator that can be used by a user to override current display settings for a visual object. In some examples, the visual object is shown in the primary display (e.g., 204) of a respective user based on a priority assignment and/or user assignment. By selecting and changing display constraints using the “Don't Display Until” function, a current user can modify the display settings associated with a visual object. In some embodiments, the changed display constraints are configured to override current settings, including for example, priority based display constraints. In still other embodiments, the changes to display constraints made by a user to a visual object are enforced for the current user making the change. Thus, in some examples, display properties can vary user by user, and more specifically, vary between a creator user and one or more responsible users, among other options.

In various embodiments, the system 100, FIG. 1 includes an activity monitor 106 that can operate in conjunction with a visual object generator 104 to update information associated with respective visual objects. For example, the selection of “Don't Display Until” date (e.g., at 212) coupled with a selection of the “Update” function shown at 214, triggers the activity monitor to generate log information with a time stamp, and the user associated with the activity. In some alternatives, the activity monitor can be configured to create time stamp/user information and provide that information to the object generator component 104 to update information on a visual object. The update can include storing the visual object information in at visual object database 110, among other options. As part of defining a visual object, a user may provide a deadline for completing tasks associated with a visual object (e.g., at 216). As discussed below, setting a deadline and passing the date state can change functionality available on the system.

In some embodiments, system 100 and/or components can be implemented as stand-alone software, a web interface, or APIs called from or integrated into other task management systems, among other options. According to one embodiment, the system 100 can be implemented as a system dubbed “Tasker” that provides optimization of user interfaces and controls to manage display and user collaboration on visual objects. Tasker can be specifically tailored to small businesses user teams and/or user teams working in a collaborative environment. The inventor has realized that most visual object management systems (including, for example, to-do list software) suffer from many problems. For some implementations, the display information (e.g., list of objects) is too simple and short, only representing daily fires that need to be put out. Such solutions are not suited and do not provide functionality to handle any complexity in respective visual objects (e.g., task), and more specifically fail to provide options for tasks that take multiple steps and/or multiple users over periods of time (e.g., days, weeks, months, etc.). For other solutions, the displayed information is too comprehensive, overwhelming the users' ability to interact with the information shown. In many examples, the comprehensive solutions represent and display every visual object (e.g., work item) even if there are no actions that can be taken for the displayed object. Thus, conventional solutions provide both too little functionality and too much. The result is wasted computer resource and wasted user resources. Various embodiments of the Tasker implementation resolve both issues. For example, the system is configured to encode visual objects that represent both “daily fires” and long-term projects. The system tailors the displays via display criteria associated with such objects so that any user can keep their focus on the visual items that can be addressed (e.g., matching any modifiable display criteria) while preventing display and wasted resources on the visual objects that cannot.

Tasker implementations can include a variety of features to manage visual objects and include functionality for tailoring user interfaces and the user's experience with visual objects. For example, the user interfaces generated on the system (e.g., via display manager 108) can include a “Don't Display Until” function. Responsive to selection of this function in the user interface, the system is configured to modify a visual object to have a “Display Date” that can be specified at any time or date in the future. In various embodiments, the system and/or display manager is configured to prevent display of any visual object until the display criteria are met. For example, regardless of a priority assigned to a visual object, the don't display function will override any other display criteria to prevent respective visual objects from appearing in a primary display of visual objects (e.g., associated with the current user).

In the context of specific tasks and collaboration that may even occur outside of the system, the system is configured to allow the current user to specify a don't display criteria for any time period, and thereby prevent the associated object from being shown in the primary display. This can be especially significant for objects that rely on outside (of the system) parties to perform an action, before the visual object can be updated. For example, if a visual object task includes an action by a counterparty that needs a specific time period to accomplish, display of that object prior to that time period wastes focus and computer resources. Once the display criteria is met, the system is configured to include the visual object in the user's primary display. For example, the system limits display of the visual object until the time expected on which the user can follow up with the external users to remind them to complete the request (if not already completed). If completed, the current user can update the visual object, assign other users, and/or sub tasks, request completion verification, among other options.

According to various embodiments, the functionality to limit display by changing display criteria on an object by object basis enables the system to streamline object management between users and conserve computer resources that would be wasted in many conventional approaches. While conventional calendaring system may allow users to schedule an appointment on the calendar to follow up, if that date is reached but the follow up is not completed on that date, often requiring a user re-schedule or in the worst case simply going unaddressed and forgotten. In various implementations of Tasker, the visual object is kept in memory and when the associated display context matches a current status (e.g., at a date in the future) the visual object is automatically displayed, and managed/displayed according to its priority information.

As discussed, any visual object's display properties can be modified (e.g., until any date in the future). The inventors have realized that may be critical to address a visual object even on a date that is months away—however, the inventor has also realized that there is no need for that visual object to take any resourced or the user's attention until that date.

According to further embodiments, the system and/or visual object generator 104 can be configured to require definition of a priority for each visual object. For example, priority can be specified to include a priority level from 0 to 4. In some embodiments, priority levels can include: 1) 0—Immediate attention; 2) 1—Must be addressed before the end of the day; 3) 2—Should be addressed within a few business days (e.g., two, three, four, five, etc.); 4) 3—Work on when free; and 5) 4—Not time sensitive. Other example priorities can be defined on the system.

Some embodiments are configured to construct primary displays of visual objects based on priority features defined for respective objects. For example, the primary display can be configured to: 1) sort list by Priority; 2) hide all items that do not meet a specified Priority threshold; and 3) automatic highlighting of tasks which have not been updated after a specified amount of time based on priority. For example, if a priority 0 task has not been updated in the last three hours, it will turn yellow. After six hours, the display of the visual object is highlighted in red. According to another example, for Priority 1, display color modifications can be based on different time thresholds—e.g., changes happen after twenty four (yellow) and forty eight (red) hours without an update. Each priority can have an associated automatic display highlighting threshold (each category can include a longer period of time relative to higher priority visual objects). The system can be configured to manage optional deadlines associated with each object. For example, a visual object can be defined with an optional deadline. As a defined deadline approaches, the system is configured to automatically update a visual object's display priority. According to one example, on the day of the deadline (or any day thereafter), the task turns hot pink and, in further embodiments, the functionality to change a display date is disabled by assigned users. In other examples, a visual object creator can update a deadline or re-enable “Don't Display Until” features but must do so through administrative displays.

In further embodiments, the system can be configured to automatically generate visual object highlighting. For example, a visual object can be highlighted in a primary display if something about the visual object requires the user's attention. Some example visual display highlighting includes: a) blue background visualization, for an object with an “unread” status. The unread status can apply when: 1) A new task assigned to the user has not been viewed by the user yet; 2) Another user modifies a task that is currently assigned to the user; and 3) an existing task has been reassigned to the user. Further embodiments are configured to automatically update a color of a visual object display with: b) Yellow highlight, where the system determines a time threshold has been exceeded since a last update to the task (e.g., the amount of time before the highlight is employed can be based on the visual object's priority); c) Red highlight, where the system determines that a further time threshold has been exceeded (e.g., twice as much time has elapsed as was needed for the visual object display to be yellow; and d) Hot Pink highlight, where the task is at or past its deadline. Upon reaching or exceeding the deadline threshold, the system is configured to disable “Don't Display” functionality—e.g., by graying out the function, blurring the function, and/or eliminating the display of the function, among other options.

According to some embodiments, the system is configured to generate and display visual objects based on a future date/time. In one example, the system is configured to construct and display a “look ahead” display by setting the current context information according to a specified user preference. According to one embodiment, the user can enter a “look ahead” date that is used by the system to set a current context or status. Various visual objects are analyzed by the system according to the current context set, resulting in a look ahead display that includes visual objects having future based display criteria. Using the look ahead context, visual objects can also be updated according to highlighting thresholds. In some embodiments, the system is configured to ignore highlighting display thresholds for look ahead displays. According to various embodiments, the system is configured to transition from a primary display to a look ahead display. For example, the system can manage a display and/or user interface so that a primary display transitions to the show only the look ahead view, according to the specified user preference. This feature provides options to allow the user to see any visual objects having display criteria that would otherwise not be shown in the primary display based on a current date and/or time. Such implementation still provides efficiencies over system that display all active tasks, as even in the look ahead context there can be visual object that are not displayed but managed/retained by the system in the database of visual objects.

In further embodiments, the system is configured to provide transparency and accountability. For example, the data of visual objects is configured to store a complete history of every modification made in association with respective visual objects. The record can be generated and stored across any team of users or based on a business entity designation. Various embodiments are configured to maintain all data produced via interaction with a visual object. For example, the system can be configured to additively modify visual objects. By only modifying the visual object database by addition, the system is configured to ensure that no data is ever destroyed. Further embodiments, incorporate timestamping information with all changes on the system, and others include user information with any timestamp. For example, in response to user access to a visual object, the action of reading it is timestamped in the database, and the associated user information can also be recorded. The system can reproduce the logged information such that no user can claim a visual object was not seen or accessed.

Various embodiments are configured to manage every modification, action, or note taken on a respective visual object to include a timestamp. For example, this prevents any user from maintaining that they have been working with or on a visual object and/or associated tasks when there have been no changes made or notes taken. The detailed view of respective visual objects provides each user with any and all progress of a task without taking time away from the assigned user working on it. In some embodiments, the system is configured to manage completion and conclusion of generated visual objects. The system can provide a gatekeeper function to the visual object creator so that completion of associated tasks encoded by the visual object require the creating user to accept a status change from active on in-progress to complete. For example, in response to a status update to the visual object marking it as complete, the system is configured to require the creating user to accept the complete or closed status. IN further example, the creating user can receive a notification from the system, which can present a separate interface for accepting the changed status (e.g., updating the visual object with a time stamped log entry showing the visual object creator accepted the completed status). The requirement for approval operates as a gateway or security function to prevent visual objects from not being displayed until the encoded actions are in fact complete. Further, the validation functionality can ensure that status changes are not made in error. For example, many conventional management software implementations permit wholesale changes of status (e.g., via ctrl select and shift select), leading to error in operation and even loss of incomplete information. In other embodiments, the system permits a creator user to close and validate a visual object with the submission of the closed status.

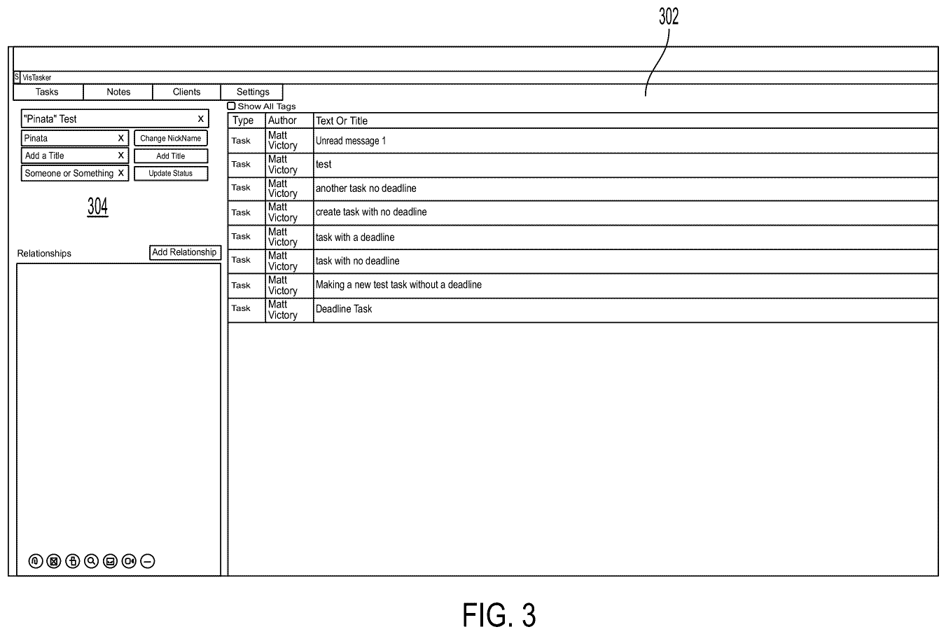

FIG. 2 is an example screen capture for user interface (UI) controlling interaction with the system (e.g., 100). As shown the UI can be configured with a primary display of existing visual objects that meet a current display context at 202. In some examples, the system uses a current date and/or time to select which visual objects are shown at 202. The system also reconciles any override information (e.g., don't display until) when generating the displayed visual objects in the primary display 202. Shown in FIG. 2 are navigation tabs that allow users to access and modify visual objects (e.g., at 220-226), as well as provide options to create new visual objects 230. The navigation tabs cause the system to transition from the first display (e.g., 200) to respective views organized based on the selected tab. FIG. 3 shows an example display 300 for clients filtered visual objects (e.g., at 302). Information fields for selected objects can be shown at 304, to permit visualization and/or modification. The assigned client can be modified and/or updated, as well presentation nickname, title, and/or relationship information, among other options. Once updated a visual object may no longer appear in the display 300 for a selected client or other context, for example, if the display context has been modified.

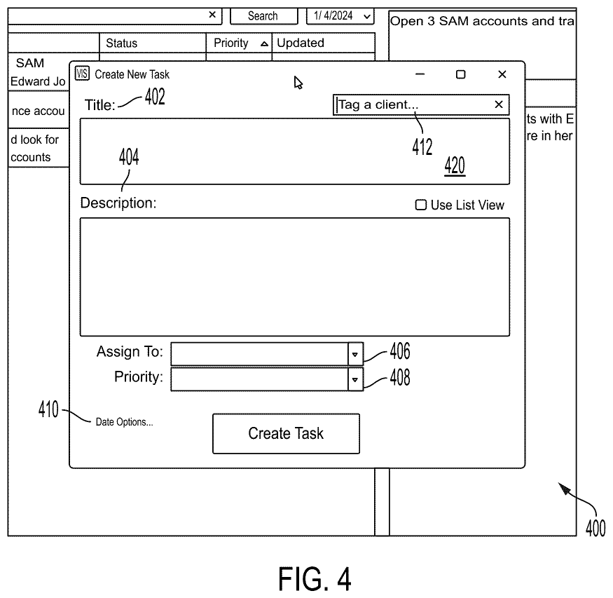

Returning to FIG. 2, the system is configured to update the primary display according to user preference (e.g., selection of Show Completed and/or Show Future Tasks at 230). Selections at 230 can be configured as additive functions, triggering the system to include completed visual objects and/or visual objects having future display criteria. The system enables users to further limit the primary display by setting a minimum priority for display of visual objects. For example, the system can provide a drop down select at 234 for requiring a priority or eliminating visual objects having less than the selected priority, among other options. UI 200 includes functionality to create new visual objects (e.g., at 230). Responsive to selection of “Create” at 230, the system is configured to generate and display an overlay user interface window 400, FIG. 4. As shown the overlay display provides for entry of title (402), description 404, assigned user 406, priority 408 (e.g., default setting 2), setting of date options 410 (e.g., don't display until, deadline, etc.), as well as specification of a specific client at 412, which can be optional in some embodiments. List view at 420, provides for definition of sub-tasks in the description field. For example, once selected, each full line entered (e.g., marked by a carriage return or enter) can be stored as a sub-task and displayed with a check box to show when each sub-task is complete. Once a new visual object is defined, selection of 430 triggers storage of the visual object in a visual object database, and the new object is evaluated against any display constraints to be included or not in respective primary displays. FIG. 5 shows an example notes display that includes all time logged activity for a respective visual object (e.g., selected in the first display (e.g., 200)). FIG. 6 shows an example view of the time logged activity for a respective visual object. In some examples, the view can be displayed as part of a first display (e.g., 200) offset from the primary display and information entry fields or as part of other displays generated by the system.

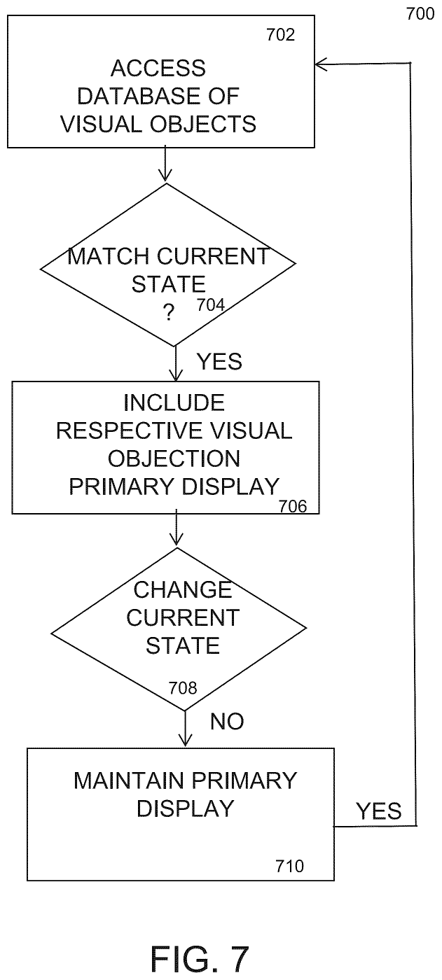

FIG. 7 illustrates an example process 700 for generating and showing a display of visual objects. Process 700 begins at 702 with access to a database of visual objects. According to one embodiment, any display characteristics or constraints are matched to a current system state and 704. For any visual objects that don't match the current state 704 no, process 700 continues at 712 and prevents display of any unmatched visual objects or display constraint. For visual objects that do match the current state 704 yes, process 700 continues to 706. At 706, the visual objects having matched display characteristics are included in the generation of a primary display.

Not shown activity monitors can actively (e.g., periodically, a-periodically, continuously, etc.) determine whether or not visual objects in the database match any change in a current state. According to some embodiments, the current state can be actively changed in response to entries on the system. For example, a user can access a “look ahead” function on the system to specify a future date as the current status. In response to a change in the current state at 708 yes, process 700 can return to 702 through 706 to update the visual objects shown in the primary display. If there is no change in current state at 708 no, process 700 can continue with maintaining the primary display at 710.

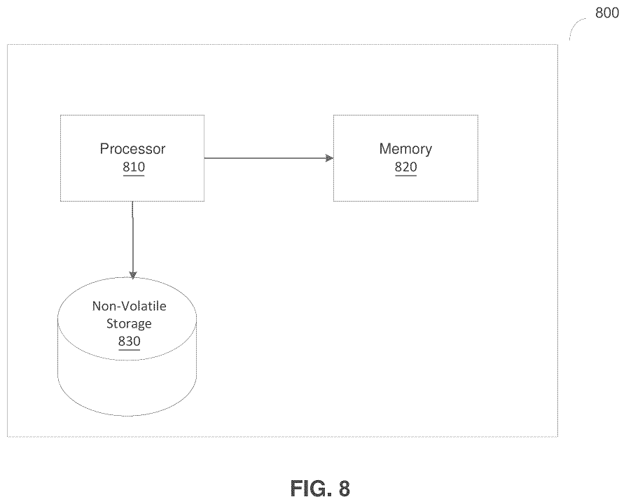

Additionally, an illustrative implementation of a special purpose computer system 800 that may be specially programmed to be used in connection with any of the embodiments of the disclosure provided herein is shown in FIG. 8. The computer system 800 may include one or more processors 810 and one or more articles of manufacture that comprise non-transitory computer-readable storage media (e.g., memory 820 and one or more non-volatile storage media 830). The processor 810 may control writing data to and reading data from the memory 820 and the non-volatile storage device 830 in any suitable manner. To perform any of the functionality described herein (e.g., build primary displays, information displays, generate visual objects, match visual objects to display constraints or characteristics, time log all activity, verify status changes, among other options), the processor 810 may execute one or more processor-executable instructions stored in one or more non-transitory computer-readable storage media (e.g., the memory 820), which may serve as non-transitory computer-readable storage media storing processor-executable instructions for execution by the processor 810.

According to some embodiments, a system for improving execution on task management objects is provided. The system can be configured for visualization and storage or productivity objects. The system can comprise at least one processor operatively connected to a memory, the at least one processor when executing configured to: generate a primary display of task objects created and encoded with modifiable display information (e.g., including calendaring information), priority, and time based log information associated with any activity performed on respective task objects; match modifiable display information to current state (time or date), and display any visual objects matching the current state excluding visual objects having non-matching current state, a datastore of visual objects comprising a plurality of visual objects encoded with the modifiable display information and the priority information, and generate, responsive to user selection, a secondary display of visual objects without filtering on the modifiable display state information.

The terms “program” or “software” or “app” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationships between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having the same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed:

1. A system for improving execution displays, the system comprising:
at least one processor operatively connected to a memory, the at least one processor when executing configured to:
generate a primary display of visual objects created and encoded with modifiable display information, priority, and time based log information associated with any activity performed on respective visual objects;
match the modifiable display information to current state, and in response to determining the match allow the display of any visual objects matching the current state and disallow the display of visual objects having non-matching current state in the primary display;
a database of visual objects comprising a plurality of visual objects encoded with the modifiable display information, the priority information, assigned user information, and data fields for log information; and
generate a visual object creation interface for accepting user specification of the modifiable display information, the priority, and the assigned user information associated with a respective visual object.

2. The system of claim 1, wherein the at least one processor is configured to generate, responsive to user selection, a secondary display of visual objects without filtering on the modifiable display state information.

3. The system of claim 2, wherein the at least one processor is configured to require a transition from the primary display to the secondary display in order to render the visual objects without filtering.

4. The system of claim 1, wherein the at least one processor is configured to generate a display of a selectable object in the user interface, the selectable object configured to accept information for controlling when a visual object can be displayed.

5. The system of claim 4, wherein the at least one processor is configured to override at least one other display property based on the information controlling when the visual object can be displayed.

6. The system of claim 1, wherein the at least one processor is configured to accept definition of a visual object including at least a title field, description field, priority field, assigned user field, an optional client field, an optional deadline field, and an optional do not display until field.

7. The system of claim 6, wherein the at least one processor is configured to present visual entry fields to collect information include the at least a title field, the description field, the priority field, the assigned user field, the optional client field, the optional deadline field, and the optional do not display until field.

8. The system of claim 1, wherein the at least one processor is configured to automatically adjust display characteristics responsive to action taken on a respective visual object.

9. The system of claim 1, wherein the at least one processor is configured to disable do not display functionality in response to a deadline associated with a respective visual object being satisfied.

10. The system of claim 1, wherein the at least one processor updates the primary display additively and in override of a current modifiable display setting responsive to selection in the user interface.

11. A method for displaying improved execution displays, the method comprising:
generating, by at least one processor, a primary display of visual objects created and encoded with modifiable display information, priority, and time based log information associated with any activity performed on respective visual objects;
matching, by the at least one processor, the modifiable display information to current state, and in response to determining the match allowing the display of any visual objects matching the current state and disallowing the display of visual objects having non-matching current state in the primary display;
maintaining, by the at least one processor, a database of visual objects comprising a plurality of visual objects encoded with the modifiable display information, the priority information, assigned user information, and data fields for log information; and
generating, by the at least one processor, a visual object creation interface for accepting user specification of the modifiable display information, the priority, and the assigned user information associated with a respective visual object.

12. The method of claim 11, further comprising generating, by the at least one processor, a secondary display of visual objects without filtering on the modifiable display state information responsive to user selection.

13. The method of claim 12, further comprising requiring, by the at least one processor, a transition from the primary display to the secondary display in order to render the visual objects without filtering.

14. The method of claim 11, further comprising generating, by the at least one processor, a display of a selectable object in the user interface, the selectable object configured to accept information for controlling when a visual object can be displayed.

15. The method of claim 14, further comprising overriding, by the at least one processor, at least one other display property based on the information controlling when the visual object can be displayed.

16. The method of claim 11, further comprising accepting, by the at least one processor, definition of a visual object including at least a title field, description field, priority field, assigned user field, an optional client field, an optional deadline field, and an optional do not display until field.

17. The method of claim 16, further comprising presenting, by the at least one processor, visual entry fields to collect information include the at least a title field, the description field, the priority field, the assigned user field, the optional client field, the optional deadline field, and the optional do not display until field.

18. The method of claim 11, further comprising automatically adjusting, by the at least one processor, display characteristics responsive to action taken on a respective visual object.

19. The method of claim 11, further comprising disabling, by the at least one processor, do not display functionality in response to a deadline associated with a respective visual object being met.

20. The method of claim 11, further comprising updating, by the at least one processor, the primary display additively and in override of a current modifiable display setting responsive to selection in the user interface.
